(19) United States
(12) Patent Application Publication
(10) Pub. No.: US 2004/0243363 A1
(43) Pub. Date: Dec. 2, 2004

(54) Method for simulating a technical system and simulator

(76) Inventor: Claus Hillermeier, Ubersee (DE)

Correspondence Address: HARNESS, DICKEY & PIERCE, P.L.C., P.O.BOX 8910, RESTON, VA, 20195, US

(21) Appl. No.: 10/487,834

(22) PCT Filed: Feb. 24, 2003
(86) PCT No.: PCT/EP03/01863

(30) Foreign Application Priority Data
Mar. 8, 2002 (EP) 02005439.1

(51) Int. Cl. G06F 17/10

(52) U.S. Cl. 703/2

(57) ABSTRACT

A method is for simulating a technical system in a number of simulating steps. in order to resolve an operational description of the technical system, the Jacobi matrix of the description is determined in a single step during each stage of simulation, without the need to resort to the formation of the difference quotients. as aresult, the signal inputs and signal outputs of a dynamic diagram representing the operational description of a technical system are expanded so that derivation data on the repspective signals can be detected according to the individual operational variables of the technical system. A simulator is used for carrying out the inventive method.

This application is the national phase under 35 U.S.C. § 371 of PCT International Application No. PCT/EP03/01863 which has an International filing date of Feb. 24, 2003, which designated the United States of America and which claims priority on European Patent Application number EP 02005439.1 filed Mar. 8, 2002, the entire contents of which are hereby incorporated herein by reference.

### FIELD OF THE INVENTION

The invention generally relates to a method and a simulator for the simulation of a technical system, in particular a power generating plant.

### BACKGROUND OF THE INVENTION

In many applications it is desirable to have a mathematical model of a technical system available, in order for example to be able to predict the operating states of the technical system that are to be expected under actual conditions. For example, it is possible to design and test a controller for the technical system without having to intervene in an actual technical system already during the design phase, which could lead to adverse effects and/or a hazardous situation arising during actual operation.

Furthermore, operating states of the technical system can be simulated by use of a simulator, for example hazardous operating states that can only be produced in the actual technical system with great effort or even by a risk being taken. Simulators of technical systems can be used particularly advantageously to train the operating personnel intended for operating the technical system in advance in all modes of operation that are to be expected, so that the operating personnel do not have to learn how to operate the technical system only when it is actually in operation.

To realize a simulator on a computer, it is necessary to describe the technical system mathematically. Most technical systems can be described by a generally non-linear differential equation of higher order.

To be able to simulate the behavior of the technical system over time on a computer, this differential equation of higher order must be solved. For solving this higher-dimensional differential equation, many known simulators and simulation programs use the equivalent so-called state-space description.

In this case, the higher-dimensional differential equation, for example of the nth degree, is transformed into n differential equations of the first degree. The equivalence between the n-dimensional differential equations and the n differential equations of the first order is sufficiently known as a state-space description, in particular in the literature on automatic control technology.

Such a state-space description includes for example the following equation of state

x′=f(x, t),

where x denotes the so-called state vector, t denotes the time and x′ denotes the time derivative of the state vector x. The function f in this case describes the system dynamics and may generally also be non-linear. If the technical system is a so-called time-invariant system, in other words the system properties do not change over time, the differential equations describing the system have constant coefficients.

If the eigenvalues of the technical system are very far apart in terms of their absolute values, one refers to “stiff” differential equations describing the system. Such eigenvalues of the system that differ considerably in their absolute values, differing for example by powers of ten, mathematically describe so-called natural oscillations of the system, which have frequencies that differ greatly from one another. This means that in this case dynamic processes occur on different time axes within the system, for example processes with low natural frequency on a macro time axis which are superposed on processes with high natural frequency on a micro time axis.

The solving of such systems of “stiff” differential equations (that is systems with natural oscillations of greatly varying frequency) in particular requires the use of particularly stable numerical solving algorithms.

A series of numerical solving algorithms, such as for example the semi-implicit Euler method or the Rosenbrock method, are known. These stated solving algorithms represent particularly stable numerical integration methods, in particular for solving the stated systems of “stiff” differential equations.

When solving the differential equations, virtually all known numerical solving algorithms calculate the so-called Jacobi matrix of the function f, the Jacobi matrix including the partial derivatives of each vector component of f respectively on the basis of all components of the state vector x.

The calculation of the Jacobi matrix in each simulation step leads to long computing times, in particular in the case of high-dimensional technical systems, since the partial derivatives have to be approximated by means of differential quotients in a number of steps.

In the known software program package Matlab/Simulink, technical systems are modeled for example by use of dynamic diagrams. Such diagrams include integrators, summers, multipliers and functional blocks (=mapping rules based for example on mathematical operations for calculating output signals from input signals present at the functional block).

The numerical differentiation for determining the Jacobi matrix requires that, to calculate a differential quotient approximating the differentiation in one simulation step, one component after the other of the state vector is varied by an amount Δ while the other components respectively of the state vector are kept constant and the dynamic diagram is run through each time. This means, for example in the case of a system of the order 100, the dynamic diagram of which consequently includes 100 integrators, that this dynamic diagram must be run through 100 times during one simulation step, a different component of the state vector being varied by an amount Δ each time for each renewed run-through, so that the Jacobi matrix required for solving the system of differential equations is approximated by means of the differential quotients determined in this way.

This requires an enormous amount of computing time in each simulation step.

To sum up, it can consequently be stated that conventional simulators which use a numerical algorithm for solving the state description of a technical system accomplish the determination of the Jacobi matrix that is generally involved by the forming of differential quotients. To determine the stated differential quotients, such numerical algorithms require a series of runs through the dynamic diagram describing the technical system in each simulation step, one of the state variables being varied slightly in each of these runs and the other state variables being kept constant. This has the result that the calculation of the Jacobi matrix is very complex.

### SUMMARY OF THE INVENTION

An embodiment of the invention is therefore based on an object of providing a method and a simulator for the simulation of a technical system. The technical system is described by a state description which includes state variables of the technical system that are particularly effective with regard to the required computing time and have a very high accuracy of the calculated solutions.

With respect to the method, an object may be achieved by a method for the simulation of a technical system in a number of simulation steps. The technical system is described by a state description which includes state variables of the technical system. The state description is represented as a dynamic diagram including combinational elements, which includes at least one summer and/or one multiplier and/or at least one functional block and/or at least one integrator, and the combinational elements respectively comprising at least one associated signal input and signal output, and the Jacobi matrix of the state description being used for solving the state description, with the following steps:

1. The number of signal inputs and signal outputs of each combinational element is extended for each signal input and signal output by a number which corresponds to the number of state variables of the technical system, so that, by way of the extended signal inputs and signal outputs, the partial derivatives of signals present at the signal inputs and signal outputs can be additionally registered on the basis of the individual state variables.

In a first simulation step, the extended signal outputs of the integrators present are respectively initialized, in that for each integrator, which is respectively provided for determining a state variable and is assigned to this state variable, an initialization value is prescribed in the extended signal outputs of said integrator at a signal position which corresponds to the state variable assigned to the integrator.

2. In following simulation steps, the Jacobi matrix is respectively determined by the signals present at the extended signal inputs of the integrators, the current values of the extended signal inputs of an integrator corresponding to the current values of a row of the Jacobi matrix, so that the entirety of the current values of the signals present at the extended signal inputs of all the integrators comprise the Jacobi matrix.

An embodiment of the invention is based on the realization that technical systems can be represented by means of interconnected combinational elements, which realize basic functions, in particular for signal processing, and a state description of the technical system can be represented by way of such combinational elements; such a representation is referred to as a dynamic diagram. In the dynamic diagram, in particular the state variables of a technical system are propagated, it being possible also to determine from the propagated state variables their time derivative.

Such a representation of a technical system in the form of a dynamic diagram can be extended according to an embodiment of the invention, in order at the same time as the propagation of the state variables of the technical system by way of the integrators of the dynamic diagram also to propagate the elements of the Jacobi matrix which correspond to the partial derivatives of each state function comprised by the state description on the basis of the individual state variables.

While in the case of known numerical simulation methods the elements of the Jacobi matrix are determined by way of a number of sequential runs through the dynamic diagram, only one of the state variables being varied each time, in the case of the method according to an embodiment of the invention, the elements of the Jacobi matrix of the state description are determined by way of a single run through the dynamic diagram. Furthermore, for the method according to an embodiment of the invention, no differential quotients are used for the approximation of the Jacobi matrix, so that the elements of the Jacobi matrix that are obtained are very accurate.

The method according to an embodiment of the invention is further distinguished by the fact that only information that relates to the original, unextended, signal inputs and outputs of the respective combinational element has to be provided at the combinational elements of the dynamic diagram; consequently, no global information, for example the information on the dimension of the state vector, is used for each combinational element—this information is for example automatically supplied implicitly in the form of the extended signals according to an embodiment of the invention—, so that the modularity of the combinational elements of the dynamic diagram extended according to the invention is retained and the combinational elements can also be (re)used for the simulation of another technical system with other global properties.

An embodiment of the invention leads furthermore to a simulator for the simulation of a technical system in a number of simulation steps, the technical system being described by a state description which comprises state variables of the technical system, the state description being represented as a dynamic diagram comprising combinational element, which includes at least one summer and/or at least one multiplier and/or at least one functional block and/or at least one integrator, and the Jacobi matrix of the state description being used for solving the state description, the number of signal inputs and signal outputs of each combinational element being extended for each signal input and signal output by a number which corresponds to the number of state variables of the technical system, and, by way of the extended signal inputs and signal outputs, the partial derivatives of signals present at the signal inputs and signal outputs being registered on the basis of the individual state variables, so that the entirety of the current values of the signals present at the extended signal inputs of all the integrators comprise the Jacobi matrix, the integrators being respectively assigned a state variable.

The statements made in connection with the method according to an embodiment of the invention likewise apply in an analogous way to a simulator according to an embodiment of the invention.

### BRIEF DESCRIPTION OF THE DRAWINGS

Further advantages, features and details of the invention will become evident from the description of illustrated embodiments given hereinbelow and the accompanying drawings, which are given by way of illustration only and thus are not limitative of the present invention, wherein:

FIG. 1 to FIG. 5 show combinational elements of a dynamic diagram with extended signal inputs and signal outputs for use in the case of a method according to an embodiment of the invention,

FIG. 6 to FIG. 7 show a state description and a dynamic diagram of a technical system according to the prior art, and

FIG. 8 shows a simulator according to an embodiment of the invention, represented by way of a dynamic diagram extended according to an embodiment of the invention.

### DETAILED DESCRIPTION OF THE PREFERRED EMBODIMENTS

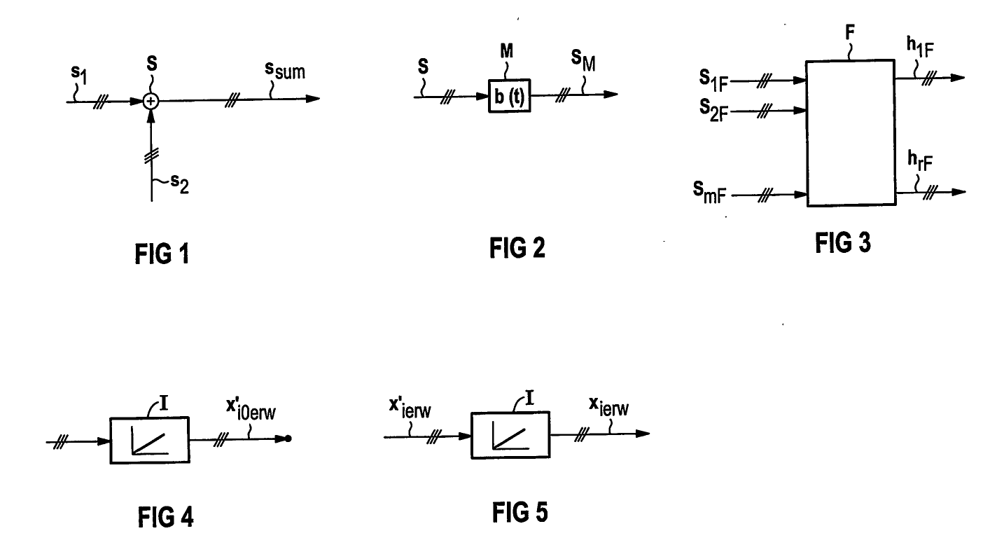

Represented in FIG. 1 to FIG. 5 are combinational elements with signal inputs and signal outputs, which are extended according to a partial aspect of an embodiment of the invention. The combinational elements include a summer S, a multiplier M, a functional block F and an integrator I.

The summer S in FIG. 1 forms from the present input signals s₁ and s₂ an output signal sₛᵤₘ, which corresponds to the sum of the input signals applied.

The multiplier M in FIG. 2 multiplies the extended input signal s by a factor b(t), which may be time-dependent, and supplies the corresponding extended output signal s_{M}.

The functional block F in FIG. 3 combines the present extended input signals s_{1F}, s_{2F}, . . . , s_{mF} and supplies h_{1F}, . . . , h_{rF} as extended output signals. In the case of the functional block F, therefore, generally m respectively extended input signals are mapped onto r respectively extended output signals. With this mapping, the input signals can be combined for example by means of known mathematical operations and a result can be formed.

FIG. 4 shows an integrator I with an extended signal input and a signal output, the extended signal output xᵢ₀ₑₓₜ carrying an initialization value for carrying out step b) of the method according to an embodiment of the invention.

Represented in FIG. 5 is the integrator I for carrying out step c) of the method according to an embodiment of the invention, x′ᵢₑₓₜ being present as the extended input signal, which comprises the time derivative of a state variable and the partial derivatives of the time derivative of the state variable on the basis of the individual state variables. The extended output signal xᵢₑₓₜ of the integrator I comprises the values of a state variable and its partial derivatives on the basis of the individual state variables.

The extended signal inputs and signal outputs occurring in FIG. 1 to FIG. 5 are now described in more detail by way of a mathematical formula, the letter v being generally used as the variable for the extended signal inputs and signal outputs; the following formation rule can be easily transferred to all the signal inputs and signal outputs occurring in FIGS. 1, 2 and 3.

$$v = ( \begin{matrix}{v}_{0} \\ \frac{δ {v}_{0}}{δ {x}_{1}} \\ \frac{δ {v}_{0}}{δ {x}_{2}} \\ ⋮ \\ \frac{δ {v}_{0}}{δ {x}_{n}}\end{matrix} )$$

This formation rule for the extended signal v is to be understood as meaning that the original, unextended, signal v₀ is extended to form a vector v by adding the partial derivatives of this original signal v₀ on the basis of the individual state variables x₁, x₂, . . . , xₙ. This means that the dimension of an extended signal input or signal output is increased by n, since the signal inputs and signal outputs of the extended combinational elements according to an embodiment of the invention of a dynamic diagram then carry in addition to the originally present signal-input or signal-output value v₀ the partial derivatives of this signal on the basis of the individual state variables.

The extended signal inputs and signal outputs represented in FIGS. 1, 2 and 3 are formed in such a way, which is indicated in the drawing by the connecting lines with three strokes through them. The formation rule for the signals of the functional block F from FIG. 3 is to be explained in more detail below.

The signal inputs s_{1F} to s_{mF} have in each case the form of the previously mentioned vector v; the output signals h_{1F} to h_{rF} are likewise formed according to the same formation rule, so that for example the first component of h_{1F} includes a functional rule which describes the mapping of the input signals s_{1F} to s_{mF} onto the functional value h_{1F} and the further components of h_{1F} comprise the partial derivatives of h_{1F} on the basis of the individual state variables. In this case, the stated partial derivatives of h_{1F} can be respectively determined on the basis of the individual state variables as the scalar product of a first and a second vector, the first vector being a row vector, which has as components the partial derivatives of h_{1F} on the basis of the input signals s_{1F} to s_{mF}, and the second vector being a column vector, which is as components the derivatives of the input signals s_{1F} to s_{mF} respectively on the basis of the state variable currently being considered. The further signals h_{2F} to h_{rF} are determined in a way analogous to h_{1F}.

The functional block F therefore provides the stated functional rule and the stated partial derivatives for a use according to an embodiment of the invention.

The extended signal output of FIG. 4, used as an initialization value, with the designation xᵢ₀ₑₓₜ, is likewise formed in a way corresponding to the above formula, with a simplification arising, since this extended signal output includes one state variable. If it is assumed, for example, that the state description of the technical system includes four state variables, in other words the corresponding dynamic diagram has four integrators and the integrator I of FIG. 4 is assigned to the second state variable, the corresponding extended signal output xᵢ₀ₑₓₜ is obtained as:

$${X}_{{i0}_{ext}} = ( \begin{matrix}{x}_{i0} \\ 0 \\ 1 \\ 0 \\ 0\end{matrix} )$$

In the first row of the signal output xᵢ₀ₑₓₜ, extended according to an embodiment of the invention, a fixed initial value xᵢ₀ is fixed for the second state variable currently being considered and, in the rows 2 to 5, the partial derivatives of the second state variable currently being considered on the basis of individual state variables are contained. Since, according to the convention of automatic control technology, the state variables of a technical system are independent from one another, there are zeros at those signal positions of the extended signal output shown by way of example that correspond to the state variables not currently being considered. Accordingly, there is a 1 only at that signal position of the extended signal output shown that corresponds to the state variable currently being considered.

This formula can likewise be used for the forming of the extended signal output xᵢₑₓₜ of FIG. 5 after omitting the index 0. This is so because FIG 1e shows the same integrator as in FIG. 4, merely during later simulation steps, once the initialization according to step b) of the method according to an embodiment of the invention, required for starting the simulation, has been completed.

Moreover, each simulation method that is based on the solving of differential equations requires at the beginning of the method a number of initialization values that corresponds to the order of the system of differential equations. Such initialization values are also referred to as initial values.

The extended signal input x′ᵢₑₓₜ represented in FIG. 5 has for the present n state variables the following form:

$${x}_{iext}^{′} = ( \begin{matrix}{x}_{i}^{′} \\ \frac{δ {x}_{i}^{′}}{δ {x}_{1}} \\ \frac{δ {x}_{i}^{′}}{δ {x}_{2}} \\ ⋮ \\ \frac{δ {v}_{0}}{δ {x}_{n}}\end{matrix} )$$

This extended signal is consequently the extended signal input of one of the integrators I, the time derivative of a state variable and the partial derivatives of the time derivative of this state variable being registered on the basis of the individual state variables.

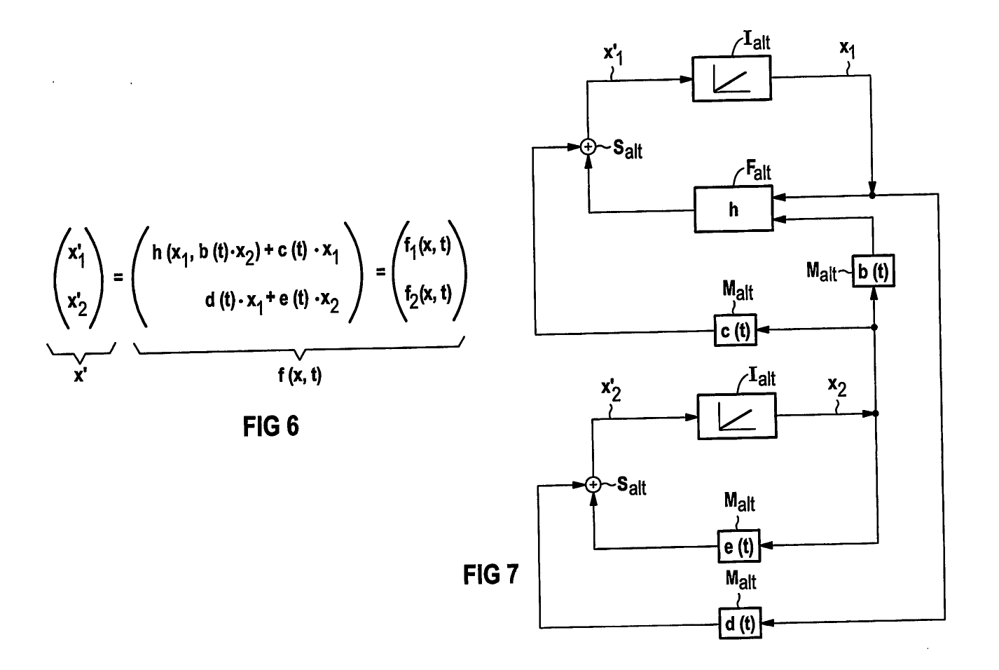

In FIGS. 6 and 7, the state descriptions f (x, t) and a corresponding dynamic diagram of a technical system are represented by way of example.

It is immediately evident from the stated state description of FIG. 6 that the technical system considered by way of example includes two independent state variables x₁ and x₂.

The state description includes two differential equations, each of the first order, whereby the time derivative of the state variables is described in dependence on the state variables.

In the state descriptions of technical systems an auxiliary function often occurs repeatedly, being called up by generally different call parameters, but the mapping rule represented by the auxiliary function remaining unchanged. An example of such an auxiliary function is a water-steam table, which is to be repeatedly evaluated for example in the simulation and/or design of a power plant, in that for example current call parameters of pressure, enthalpy, temperature and volume of a water flow are used to calculate the corresponding amount of steam.

In the simple example of FIGS. 6 and 7, an auxiliary function which is evaluated once per simulation step is represented, but it is possible, and characteristic of technical systems, in particular power generating plants, that their state description comprises an auxiliary function repeatedly, in other words said auxiliary function is repeatedly evaluated during a simulation step.

FIG. 7 shows a dynamic diagram corresponding to the state description of FIG. 6, according to the prior art, each connecting line carrying only one signal.

The time derivatives of the state variables x′₁ and x′₂ are present at the inputs of the integrators I_{old}; the outputs of the integrators accordingly carry the state variables x₁ and x₂. In a way corresponding to the combinational rules formulated by the state description of FIG. 6, combinational elements S_{old}, M_{old}, F_{old} and the stated integrators I_{old} are provided in the dynamic diagram in FIG. 7; the index “old” in this case relates to known combinational elements according to the prior art.

The combinational element S_{old} corresponds to a summer, which adds the input signals present at it and outputs a corresponding sum signal.

The combinational element M_{old} represents a multiplier, which multiplies an input signal present at it by a generally time-dependent factor and emits a corresponding output signal; in the example of FIG. 7, multiplications of the respectively present input signals by time-dependent factors b (t), c (t), d (t) and e (t) are respectively provided for the combinational elements M_{old}.

The combinational element F_{old} realizes the auxiliary function h comprised in FIG. 6, the state variable x₁, present as an input signal, and the state variable x₂, multiplied by the factor b (t), as a likewise present input signal, being used to calculate an output value, for example in the case of a power generating plant a generated amount of steam when a certain amount of water is present at a certain pressure and a certain temperature and a certain enthalpy.

The representations of the state description of a technical system represented alongside one another in FIGS. 6 and 7 are of equivalent value, the representation of FIG. 7 as a dynamic diagram being technically oriented and, for example, easily able to be implemented in a data-processing system. Very many known simulators are based on dynamic diagrams corresponding to FIG. 7.

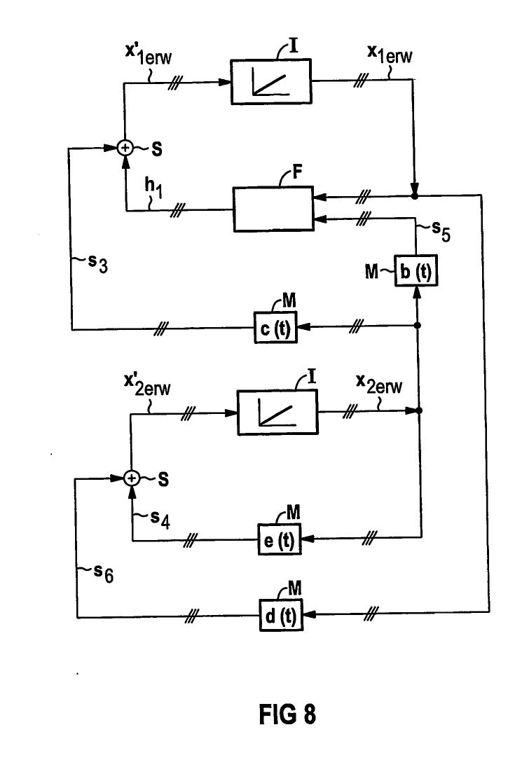

Represented in FIG. 8 is a dynamic diagram with which a method according to the invention can be carried out. Furthermore, a dynamic diagram corresponding to FIG. 8 can be implemented in a data-processing system, so that a simulator according to an embodiment of the invention is realized.

In order to illustrate the extensions according to an embodiment of the invention of a known dynamic diagram, for example as represented in FIG. 7, the dynamic diagram of FIG. 7 has been taken as a basis in FIG. 8 and extended according to an embodiment of the invention. A restriction of the method according to an embodiment of the invention or of the simulator according to the invention to the dynamic diagram represented in FIG. 7 is not intended; rather, dynamic diagrams of any type, structure and complexity can be extended according to an embodiment of the invention.

A major difference of the dynamic diagram extended according to an embodiment of the invention of FIG. 8 in comparison with the known dynamic diagram of FIG. 7 is that the lines of FIG. 8 by which the combinational elements are connected now carry in each case not only a signal but parallel thereto the derivatives of the respectively carried signal on the basis of individual state variables, so that in the case of the presence of n state variables each line now carries n+1 signals. The combinational elements S, M, F and I of FIG. 8 must consequently process vectors of signals. The input and output signals s₃, s₄, s₅, s₆, x′₁ₑₓₜ, x₁ₑₓₜ, h₁, x′₂ₑₓₜ, x₂ₑₓₜ are formed in a way corresponding to the formulae as they are specified in connection with FIGS. 1 to 5. It consequently follows that, by way of FIG. 8, a method according to an embodiment of the invention for the simulation of a technical system is described in a number of simulation steps, the extended signal outputs x₁ₑₓₜ and x₂ₑₓₜ of the integrators I respectively being initialized in a first simulation step, in that for each integrator I, which is respectively provided for determining a state variable x₁, x₂ and is assigned to this state variable, an initialization value is prescribed in the extended signal output x₁ₑₓₜ, x₂ₑₓₜ of the respective integrator at a signal position which corresponds to the state variable assigned to the integrator; a simulator according to the invention can be realized by way of the dynamic diagram shown by way of example, for example by programming techniques in a data-processing system.

A next simulation step includes the calculation of a current value for all the extended signals occurring in the dynamic diagram of FIG. 8; taking as a basis a value of the outputs of the integrators I that is respectively currently present—in the case of the first simulation step, as mentioned above, the prescribed initialization values—, that is to say current values for the extended state variables x₁ₑₓₜ and x₂ₑₓₜ, and these signals then being distributed to the combinational elements in a way corresponding to the lines represented in the FIG, until the current values for the time derivative of the extended state variables x′₁ and x′₂ₑₓₜ are present at the integrator inputs.

The next and following simulation steps include the integration of the time derivatives of the extended state variables x′₁ₑₓₜ and x′₂ₑₓₜ by the integrators I, until there are at the integrator outputs further current values for the extended state variables, with which the dynamic diagram is then run through again for the respectively following simulation step.

In the case of the method according to an embodiment of the invention, for each simulation step the current values of the time derivatives of the extended state variables x′₁ₑₓₜ and x′₂ₑₓₜ, that is to say the current values of the signal inputs of the integrators I, comprise the Jacobi matrix, the current values of the signal input of each integrator I respectively comprising one row of the Jacobi matrix.

According to an embodiment of the invention, the following signal is present at the extended signal input of the integrator I depicted at the top in FIG. 8:

$${x}_{1 ext}^{′} = {( \begin{matrix}{x}_{1}^{′} \\ \frac{δ {x}_{1}^{′}}{δ {x}_{1}} \\ \frac{δ {x}_{1}^{′}}{δ {x}_{2}}\end{matrix} )}^{T} = {( \begin{matrix}h ( {x}_{1} , b ( t ) \cdot {x}_{2} ) + c ( t ) \cdot {x}_{2} \\ \frac{δ {f}_{1} ( x , t )}{δ {x}_{1}} \\ \frac{δ {f}_{1} ( x , t )}{δ {x}_{2}}\end{matrix} )}^{T} \begin{matrix}← {f}_{1} ( x , t ) \\ \{ \begin{matrix}first row of the \\ Jacobi matrix \end{matrix}\end{matrix}$$

It is immediately evident that the above signal includes the first row of the Jacobi matrix to be determined in step c of the method according to an embodiment of the invention.

A signal which comprises the second row of the Jacobi matrix to be determined in step c of the method according to the invention is present at the extended signal input of the integrator I represented at the bottom in FIG. 8:

$${x}_{2 ext}^{′} = {( \begin{matrix}{x}_{2}^{′} \\ \frac{δ {x}_{2}^{′}}{δ {x}_{1}} \\ \frac{δ {x}_{2}^{′}}{δ {x}_{2}}\end{matrix} )}^{T} = {( \begin{matrix}d ( t ) \cdot {x}_{1} + ⅇ ( t ) \cdot {x}_{2} \\ \frac{δ {f}_{2} ( x , t )}{δ {x}_{1}} \\ \frac{δ {f}_{2} ( x , t )}{δ {x}_{2}}\end{matrix} )}^{T} \begin{matrix}← {f}_{2} ( x , t ) \\ \{ \begin{matrix}second row of the \\ Jacobi matrix \end{matrix}\end{matrix}$$

Since the two stated rows of the Jacobi matrix are determined in parallel during a simulation step when running through the dynamic diagram, consequently the Jacobi matrix of the state description is determined in its entirety and in one run through the dynamic diagram in each simulation step, without it being envisaged, as in the prior art, that differential quotients have to be formed and evaluated in a number of simulation substeps of each simulation step.

It goes without saying that the method according to an embodiment of the invention and the simulator according to the invention can be used in the case of technical systems of any order; the restrictions to the order 2, made for the sake of simplicity in FIGS. 6 to 8, serve only for explanatory purposes. This means that even high-dimensional technical systems can be simulated by way of the method or simulator according to an embodiment of the invention, the Jacobi matrix of their respective state description being determined in one go in each simulation step.

To sum up, it can be stated that, in the case of a method according to an embodiment of the invention and a simulator according to an embodiment of the invention, the stated derivative information is also propagated in addition to the state variables. Accordingly, each signal line of the dynamic diagram then carries a (n+1)-dimensional vector instead of a scalar signal, n corresponding to the number of state variables. The rule as to how the stated vector is to be transformed at the individual combinational elements is derived from the differentiation rules of analysis (summer: sum rule; multiplier: product rule; functional block: chain rule). What is important is the technical realization that the stated transformations can respectively take place locally in the combinational elements, that is to say that, apart from the respective extended signal input vector and a transformation ruled realized in the combinational element (according to the stated differentiation rules), a combinational element does not require any further information that is not locally available. This results inter alia in the great technical advantage whereby, according to an embodiment of the invention, extended combinational elements can be stored for example as modules in a software library and be used again for the simulation of other technical systems, since the combinational elements do not include any global information of the technical system.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for the simulation of a technical system in a number of simulation steps, with the technical system being described by a state description which includes state variables of the technical system, the state description being represented as a dynamic diagram including combinational elements which include at least one of at least one summer, at least one multiplier, at least one functional block and at least one integrator, and the combinational elements respectively including at least one associated signal input and signal output, and a Jacobi matrix of the state description being used for solving the state description, the method comprising
extending the number of signal inputs and signal outputs of each combinational element, for each signal input and signal output, by a number which corresponds to the number of state variables of the technical system, so that, using the extended signal inputs and signal outputs, partial derivatives of signals present at the signal inputs and signal outputs are additionally registerable on the basis of the individual state variables;
respectively initializing, in a first simulation step, the extended signal outputs of the integrators present, wherein for each integrator, respectively provided for determining a state variable and assigned to this state variable, an initialization value is prescribed in the extended signal outputs of said integrator at a signal position which corresponds to the state variable assigned to the integrator; and
respectively determining the Jacobi matrix, in following simulation steps, by the signals present at the extended signal inputs of the integrators, the current values of the extended signal inputs of an integrator corresponding to the current values of a row of the Jacobi matrix, so that the entirety of the current values of the signals present at the extended signal inputs of all the integrators comprises the Jacobi matrix.

2. A simulator for the simulation of a technical system in a number of simulation steps, wherein the technical system is described by a state description which includes state variables of the technical system, the state description being represented as a dynamic diagram including combinational elements, which include at least one of at least one summer, at least one multiplier, at least one functional block and at least one integrator, and wherein a Jacobi matrix of the state description is used for solving the state description, the simulator comprising:
means for extending the number of signal inputs and signal outputs of each combinational element, for each signal input and signal output, by a number which corresponds to the number of state variables of the technical system; and
means for registering, using the extended signal inputs and signal outputs, the partial derivatives of signals present at the signal inputs and signal outputs on the basis of the individual state variables, so that the entirety of the current values of the signals present at the extended signal inputs of all the integrators comprises the Jacobi matrix, the integrators being respectively assigned a state variable.

3. A method for simulating a technical system, the technical system being described by a state description including state variables of the technical system, the state description being represented as a dynamic diagram of combinational elements and a Jacobi matrix of the state description being used for solving the state description, the method comprising:
using extended signal inputs and signal outputs of each combinational element, extended by a number corresponding to the number of state variables of the technical system, to register partial derivatives of signals present at the signal inputs and signal outputs on the basis of the individual state variables;
initializing the extended signal outputs of integrators, wherein for each integrator an initialization value is prescribed in the extended signal outputs of said integrator at a signal position which corresponds to the state variable assigned to the integrator; and
determining the Jacobi matrix from the signals present at the extended signal inputs of the integrators, wherein current values of the extended signal inputs of an integrator correspond to the current values of a row of the Jacobi matrix, and wherein the entirety of the current values of the signals present at the extended signal inputs of all the integrators comprises the Jacobi matrix.

4. A simulator for simulation of a technical system, the technical system being described by a state description including state variables of the technical system and wherein a Jacobi matrix of combinational elements of the state description is used for solving the state description, the simulator comprising:
means for extending signal inputs and signal outputs of the combinational elements by a number corresponding to the number of state variables of the technical system; and
means for using the extended signal inputs and signal outputs to register the partial derivatives of signals present at the signal inputs and signal outputs on the basis of the individual state variables.

5. The simulator of claim 4, wherein an entirety of the current values of the signals present at the extended signal inputs of all the integrators comprises the Jacobi matrix, the integrators being respectively assigned a state variable.

6. A method for simulating a technical system, the technical system being described by a state description including state variables of the technical system, wherein a Jacobi matrix of combinational elements of the state description is used for solving the state description, the method comprising:
extending signal inputs and signal outputs of the combinational elements by a number corresponding to the number of state variables of the technical system; and
using the extended signal inputs and signal outputs to register the partial derivatives of signals present at the signal inputs and signal outputs on the basis of the individual state variables.

7. The method of claim 6, wherein an entirety of the current values of the signals present at the extended signal inputs of all the integrators comprises the Jacobi matrix, the integrators being respectively assigned a state variable.
